(19) United States
(12) Patent Application Publication
(10) Pub. No.: US 2006/0251962 A1
(43) Pub. Date: Nov. 9, 2006

(54) Secondary battery

(75) Inventor: Kwanchun Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/408,986

(22) Filed: Apr. 24, 2006

(30) Foreign Application Priority Data
Apr. 26, 2005 (KR) 2005-34744

(51) Int. Cl. H01M 2/18; H01M 2/08; H01M 2/16

(52) U.S. Cl. 429/130; 429/94; 429/185; 429/144

(57) ABSTRACT

A secondary battery, including a jelly-roll shaped electrode assembly in which first and second electrode plates coated with active material layers having different polarities are wound together with a separator interposed therebetween, a fixing tape disposed around the jelly-roll shaped electrode assembly having a predetermined elasticity so as to maintain a winding state of the jelly-roll shaped electrode assembly, a case to receive the jelly-roll shaped electrode assembly, and a cap assembly to seal the case.

### CROSS-REFERENCE TO RELATED APPLICATION

This application claims the benefit of Korean Application No. 2005-34744, filed Apr. 26, 2005, in the Korean Intellectual Property Office, the disclosure of which is incorporated herein by reference.

### BACKGROUND OF THE INVENTION

1. Field of the Invention

An aspect of the present invention relates to a secondary battery. More particularly, an aspect of the present invention relates to a secondary battery including a jelly-roll type electrode assembly.

2. Description of the Related Art

Recently, electric/electronic appliances having a compact size and light weight, such as cellular phones, notebook computers and camcorders, have been actively developed and produced. Such electric/electronic appliances are equipped with battery packs so that users may use the electric/electronic appliances in various places even if electric power sources are not separately provided for. These conventional battery packs include at least one bare cell that is capable of outputting an operational voltage having a predetermined level in order to operate portable electric/electronic appliances for a predetermined period of time.

Secondary batteries, which are rechargeable batteries, are currently employed in these battery packs due to their economical advantages. Such secondary batteries include Ni—Cd batteries, Ni-MH batteries and Li secondary batteries, such as Li batteries or Li-ion batteries.

Among other things, the lithium secondary batteries have an operational voltage of about 3.6V, which is three times higher than that of Ni—Cd batteries or Ni-MH batteries used as power sources for the portable electronic appliances. In addition, the lithium secondary batteries have high energy density per unit weight properties. As such, lithium secondary batteries are extensively used in the advanced electronic technology fields.

The lithium secondary battery uses lithium-based oxide as a positive electrode active material and carbon as a negative electrode active material. In general, the lithium secondary batteries are classified into liquid electrolyte batteries and polymer electrolyte batteries according to the type of the electrolytes being used. The liquid electrolyte batteries are referred to as “lithium ion batteries,” and the polymer electrolyte batteries are referred to as “lithium polymer batteries”. In addition, the lithium secondary batteries may be fabricated with various shapes, such as cylinder type lithium secondary batteries, square type lithium secondary batteries, or pouch type lithium secondary batteries.

Typically, the lithium secondary battery, which is used as a power source for a small electronic appliance, includes an electrode assembly in which a positive electrode plate is coated with a positive electrode active material, a negative electrode plate is coated with a negative electrode active material and a separator is interposed between the positive electrode plate and the negative electrode plate to prevent a short circuit while allowing the lithium-ions to move, a case to receive the electrode assembly therein, and an electrolyte contained in the case in order to enable lithium-ions to move.

In such a lithium secondary battery, the positive electrode plate coated with the positive electrode active material is connected to a positive electrode tap. The positive electrode plate is stacked with the negative electrode plate, which is coated with the negative electrode active material and which is also connected to a negative electrode tap. The separator is interposed therebetween and the positive electrode plate, the negative electrode plate, and the separator are then wound in the form of a jelly-roll to form the electrode assembly.

The electrode assembly is then accommodated in the case such that the electrode assembly is prevented from separating from the can. Then, the electrolyte is injected into the case and the case is sealed, thereby obtaining the lithium secondary battery.

At this time, a fixing tape is attached to the electrode assembly such that the whole area of the outer surface of the electrode assembly may be surrounded. The electrode assembly, having the fixing tape applied thereto, is pressed to form the jelly-roll type electrode assembly.

However, according to the conventional jelly-roll type electrode assembly, lithium ions of the positive electrode active material layer coated with the lithium-based oxide may move into the negative electrode active material layer made of carbonic materials, such as graphite, during the charge/discharge operations. The lithium ions are intercalated between carbonic molecules, thereby expanding the negative electrode plate. Also, as the negative electrode plate expands, the electrode assembly will be deformed. In addition, since the fixing tape securely holds end portions of the electrode plates even if the negative electrode plate expands, front portions of the electrode plates, which are wound together by means of a winding machine, may be deformed. This is because, otherwise, the fixing tape may be detached from the end portions of the electrode plates due to the expansion of the electrode assembly. In this case, the electrode assembly is shrunk during the discharge operation, so that a gap may be formed between the electrode plates and the separator. As the charge/discharge operations repeat, lithium metals may be created in the gap formed between the electrode plates and the separator, thereby causing a short circuit. Lastly, in addition, if the fixing tape strongly holds the end portions of the electrode plates, the fixing tape interrupts the charge operation of the secondary battery while preventing the negative electrode plate from being deformed, so that the charge capacity of the secondary battery may be reduced.

### SUMMARY OF THE INVENTION

Accordingly, aspects of the present invention solve the above-mentioned and/or other problems occurring in the related art, and provide a secondary battery, in which a fixing tape surrounding an electrode assembly of the secondary battery expands proportionally to an expansion of the electrode assembly, and the electrode assembly, which is wound in the form of a jelly-roll, may be released during the discharge operation so that the electrode assembly may return to a state in effect before the charge operation without forming a gap between electrode plates and a separator.

In order to accomplish the above and/or other aspects, according to one aspect of the present invention, there is provided a secondary battery comprising: a jelly-roll type electrode assembly obtained by winding first and second electrode plates coated with active material layers having different polarities together with a separator; a fixing tape having a predetermined elasticity so as to maintain a winding state of the jelly-roll type electrode assembly; a case for receiving the jelly-roll type electrode assembly; and a cap assembly for sealing the case.

According to the exemplary embodiment of the present invention, the fixing tape includes a substrate having a predetermined elasticity and an adhesive layer coated on the substrate. The substrate is made from a rubber material, which includes styrene butadiene rubber or acrylonitrile butadiene rubber. The substrate is made of a material having a softening point of about 150° C. or more. The substrate has an elastic coefficient within a range of 1 MPa to 10 MPa. The fixing tape has a mesh structure. The adhesive layer is made of acryl, which has an adhesion strength of about 200 g/mm or less. The first electrode plate is a negative electrode plate. The case includes a square type case. The case includes a cylinder type case.

The fixing tape surrounds an outer surface of the electrode assembly. The fixing tape is attached to side end portions of the electrode assembly, for instance, side end portions of the separator which meet while facing each other after the electrode assembly has been wound. The fixing tape surrounds a lower end portion of the electrode assembly.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1 to 3 are perspective views illustrating a jelly-roll type electrode assembly and a fixing tape according to one embodiment of the present invention;

FIG. 4 is a perspective view illustrating a fixing tape according to another embodiment of the present invention; and

FIG. 5 is a perspective view illustrating a secondary battery equipped with an electrode assembly according to one embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

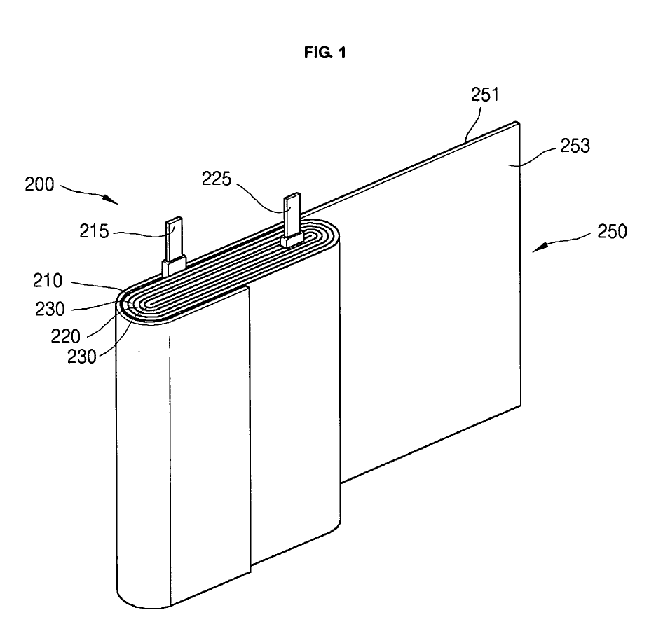

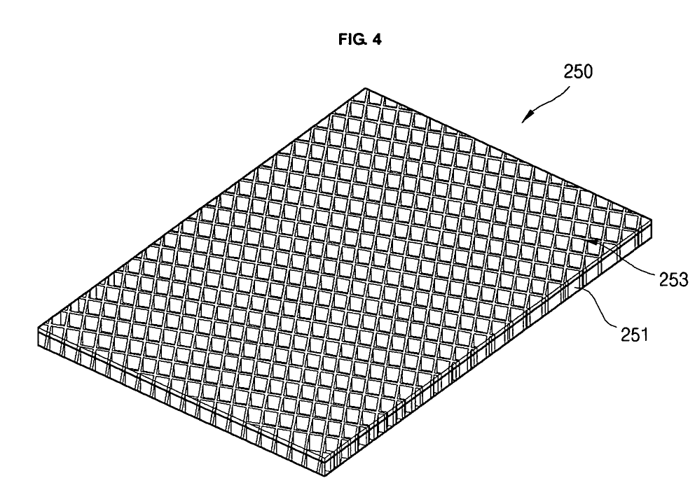

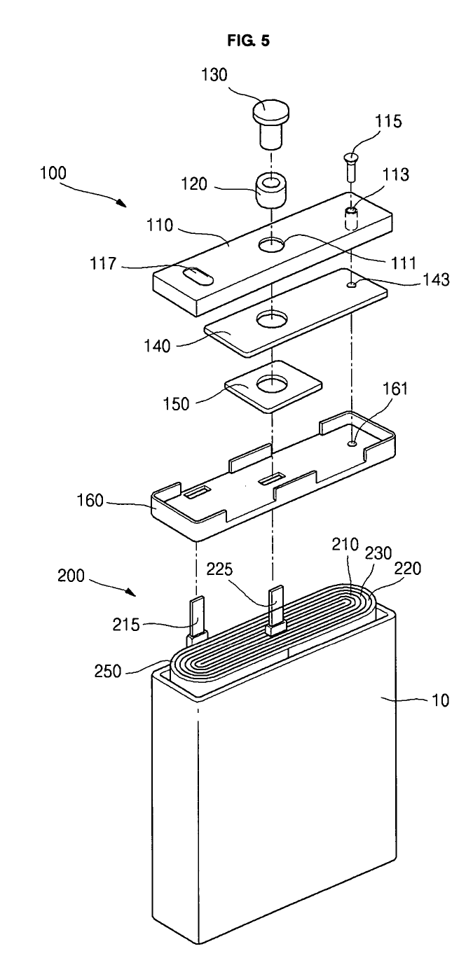

FIGS. 1 to 3 are perspective views illustrating a jelly-roll (or spiral) type electrode assembly and a fixing tape according to one embodiment of the present invention, and FIG. 4 is a perspective view illustrating a fixing tape according to another embodiment of the present invention. Referring to FIGS. 1 to 4, the jelly-roll type electrode assembly 200 is accommodated in a case 10 (see, FIG. 5). In this state, an electrolyte is injected into the case 10 and a cap assembly 100 (see, FIG. 5) is assembled onto an upper portion of the case 10.

The case 10 is made from a metallic material and serves as a terminal. In addition, the case 10 may be formed in various structures, such as a cylindrical structure or a square structure.

The electrode assembly 200 includes a first electrode plate 210 provided with a first electrode tap 215, a second electrode plate 220 provided with a second electrode tap 225, and a separator 230 interposed between the first and second electrode plates 210 and 220. The first and second electrode plates 210 and 220 and the separator 230 are wound together. That is, the first electrode plate 210, the second electrode plate 220 and the separators 230 each form strips and are stacked in the order of the first electrode plate 210, the separator 230, the second electrode plate 220 and the separator 230. Then, they are wound in the form of a jelly-roll (or spiral) to form the jelly-roll type electrode assembly 200. The jelly-roll type electrode assembly 200 is fixed by a fixing tape 250, which will be described later in detail.

The first electrode plate 210 may serve as a positive electrode plate and may include a first electrode collector made from a metallic thin plate having superior conductivity, such as aluminum foil, and a first active material layer coated on the first electrode collector. Chalcogenide compound may be used as first active materials. For instance, composite metallic oxides, such as LiCoO₂, LiMn₂O₄, LiNiO₂, LiNi₁₋ₓCoₓO₂ (0<x<1), or LiMn₂O₂, are used as first active materials. However, the present invention does not limit the first active materials.

First uncoated portions, on which the first active material layer is not coated, are formed at both end portions of the first electrode collector of the first positive electrode plate 210, respectively. The first electrode tap 215 is electrically attached to one of the first uncoated portions.

The second electrode plate 220 may serve as a negative electrode plate and may include a second electrode collector made from a metallic thin plate having superior conductive properties, such as a copper foil or a nickel foil, and a second active material layer coated on both surfaces of the second electrode collector. Carbon-based materials, Si, Sn, tin oxides, composite tin alloys, transition metal oxides, lithium metal nitrides or lithium metal oxides may be used as second active materials. However, the present invention is not limited to these active materials. Second uncoated portions, on which the second active material layer is not coated, are formed at both end portions of the second electrode collector of the second electrode plate 220, respectively. The second electrode tap 225 is electrically attached to one of the second uncoated portions in opposition to the first electrode tap 215 of the first electrode plate 210.

The separator 230 prevents a short circuit from occurring between the first and second electrode plates 210 and 220 while allowing electric charges of the lithium secondary battery (for example, lithium ions) to move freely. The separator 230 includes materials selected from the group consisting of polyethylene, polypropylene, and copolymer of polyethylene and polypropylene. However, the present invention is not limited to these materials. In accordance with an embodiment of the invention, a width of the separator 230 is larger than that of the first electrode 210 or the second electrode 220 in order to more effectively prevent short circuits from occurring between the first and second electrode plates 210 and 220.

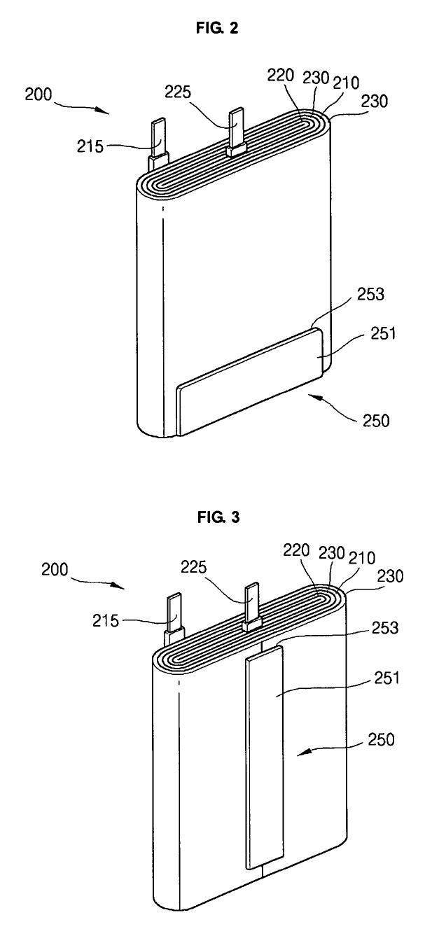

The fixing tape 250 is attached to the jelly-roll type electrode assembly 200 so as to prevent the first and second electrode plates 210 and 220 and the separator 230 from being released. As shown in FIG. 1, the fixing tape 250 may be attached to the jelly-roll type electrode assembly 200 such that the fixing tape 250 surrounds the whole area of an outer surface of the jelly-roll type electrode assembly 200. In addition, as shown in FIG. 2, the fixing tape 250 may be attached to the jelly-roll type electrode assembly 200 such that the fixing tape 250 surrounds only a lower portion of the outer surface of the jelly-roll type electrode assembly 200. Furthermore, as shown in FIG. 3, the fixing tape 250 may be attached to side end portions of the jelly-roll type electrode assembly 200, which may meet while facing each other after the first and second electrode plate 210 and 220 and the separator 230 of the jelly-roll type electrode assembly 200 have been wound.

An adhesive layer of the fixing tape may be formed over the whole area of a substrate of the fixing tape or may be formed on both end portions of the substrate along the expansion/contraction direction of the fixing tape. If the adhesive layer of the fixing tape is formed over the whole area of the substrate of the fixing tape, an elasticity of the substrate may be lowered while the adhesive force of the adhesive layer may be increased. As such, expansion/contraction of the fixing tape may be interrupted due to the adhesive layer.

The fixing tape 250 has a predetermined elasticity. That is, the fixing tape 250 comprises a substrate 251 having an elastic coefficient within a range of 1 MPa to 10 MPa and an adhesive layer 253 coated on the substrate 251.

If the elastic coefficient is too low, the fixing tape 250 may not sufficiently strain the end portion of the electrode assembly when the electrode assembly returns to the state before the charge operation. As a result, the electrode assembly may end up appearing to be roughly wound. In this case, a gap may be formed between the electrode plates and the separator of the electrode assembly. In contrast, if the elastic coefficient is too high, the fixing tape 250 may not provide the required elasticity. That is, the fixing tape may be released from the end portion of the electrode assembly, or the negative electrode active material may not be able to sufficiently expand, thereby interrupting the charge operation.

In accordance with an embodiment of the invention, the substrate 251 of the fixing tape 250 comprises a rubber material having a predetermined elasticity. That is, the fixing tape 250 having the substrate 251 must be able to expand with the electrode assembly 200 when the electrode assembly 200 expands due to the movement of electrons during the charge/discharge operations of the secondary battery. In addition, the substrate 251 of the fixing tape 250 should, although not necessarily, be made from a material having a softening point of about 150° C. or more such that the substrate 251 may be prevented from being deformed by heat generated during the charge/discharge operations of the secondary battery.

In accordance with an embodiment of the invention, the rubber material for the substrate 251 of the fixing tape 250 includes styrene butadiene rubber, which has superior heat-resistant and erosion-resistant characteristics and which is not easily deformed, or acrylonitrile butadiene rubber having superior tensile strength and elastic characteristics. In addition, the rubber material for the substrate 251 of the fixing tape 250 may be able to elongate to approximately 200% or more of an original length.

As shown in FIG. 4, the substrate 251 of the fixing tape 250 comprises a mesh structure. Accordingly, the substrate 251 of the fixing tape 250 comprises a plurality of holes, so that the substrate 251 may be relatively easily expanded due to the holes when the electrode assembly 200 expands.

The adhesive layer 253 comprises acryl having an adhesion strength of approximately 200 g/mm or less. If the adhesion strength of the adhesive layer 253 exceeds 200 g/mm, the substrate 251 may not expand as required when the electrode assembly 200 is expanded.

As is described above, the jelly-roll type electrode assembly 200 is accommodated in the square-type case 10 and is sealed by the cap assembly 100 as shown in FIG. 5.

The cap assembly 100 comprises a substantially flat cap plate 110 having a shape and a size corresponding to a shape and a size of the opening of the case 10. A terminal hole 111 and an electrolyte injection hole 113 are formed at a center and a side of the cap plate 110, respectively. The electrolyte is injected into the case 10 through the electrolyte injection hole 113. A plug 115 is inserted into the electrolyte injection hole 113 in order to seal the electrolyte injection hole 113.

An electrode terminal 130, for instance, a negative electrode terminal is inserted into the terminal hole 111. A tube-shaped gasket 120 is fitted around the electrode terminal 130 in order to electrically insulate the electrode terminal 130 from the cap plate 110. An insulating plate 140 is provided below the cap plate 110 and a terminal plate 150 is provided below the insulating plate 140.

The electrode terminal 130, which is surrounded by the gasket 120, is inserted into the terminal hole 111. A lower portion of the electrode terminal 130 is electrically connected to the terminal plate 150 through the insulating plate 140.

The first electrode tap 215 extends from the first electrode plate 210 and is welded to a lower surface of the cap plate 110. The second electrode tap 225 extends from the second electrode plate 220 and is welded to a lower portion of the electrode terminal 130.

Meanwhile, an insulating case 160 is provided at an upper surface of the electrode assembly 200 to electrically insulate the electrode assembly 200 from the cap assembly 100 while covering an upper end portion of the electrode assembly 200. The insulating case 160 is formed with an electrolyte passage hole 161 aligned to correspond in location to the electrolyte injection hole 113 of the cap plate 110 so as to allow the electrolyte to be introduced into the case 10. The insulating case 160 comprises polymer resin having superior insulating characteristics. According to an embodiment of the invention, the insulating case 160 is made from polypropylene. However, the present invention is not limited to the use of these materials for the insulating case 160.

Meanwhile, according to another embodiment of the present invention, the jelly-roll type electrode assembly 200 may be accommodated in a cylinder type case while being sealed by the cap assembly 100.

According to aspects of the present invention, the electrode assembly 200 is fixed by the fixing tape 250 being made from a permeable material, which allows electrolytes or ions to pass through, and is accommodated in the case 10 of the secondary battery, so that the electrode assembly is prevented from being released even if the internal temperature of the secondary battery rises.

As is described above, according to aspects of the present invention, the fixing tape, which is used to fix the electrode assembly when the electrode assembly is wound in the form of the jelly-roll, has a predetermined elasticity, so that the fixing tape expands together with the electrode assembly during the charge/discharge operation of the secondary battery, thereby preventing the electrode assembly from being released.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A secondary battery, comprising:
a jelly-roll shaped electrode assembly in which first and second electrode plates coated with active material layers having different polarities are wound together with a separator interposed therebetween;
a fixing tape disposed around the jelly-roll shaped electrode assembly having a predetermined elasticity so as to maintain a winding state of the jelly-roll shaped electrode assembly;
a case to receive the jelly-roll shaped electrode assembly; and
a cap assembly to seal the case.

2. The secondary battery according to claim 1, wherein the fixing tape comprises a substrate having a predetermined elasticity and an adhesive layer coated on the substrate.

3. The secondary battery according to claim 2, wherein the substrate comprises a rubber material.

4. The secondary battery according to claim 3, wherein the rubber material includes styrene butadiene rubber or acrylonitrile butadiene rubber.

5. The secondary battery according to claim 3, wherein the substrate is made of a material having a softening point of about 150° C. or more.

6. The secondary battery as claimed in claim 2 or 3, wherein the substrate has an elastic coefficient within a range of 1 MPa to 10 MPa.

7. The secondary battery as claimed in claim 1, wherein the fixing tape comprises a mesh structure.

8. The secondary battery as claimed in claim 2, wherein the adhesive layer icomprises acryl.

9. The secondary battery as claimed in claim 8, wherein the acryl has an adhesion strength of about 200 g/mm or less.

10. The secondary battery as claimed in claim 1, wherein the fixing tape surrounds an outer surface of the electrode assembly.

11. The secondary battery as claimed in claim 1, wherein the fixing tape is attached to side end portions of the electrode assembly, which meet while facing each other after the electrode assembly has been wound.

12. The secondary battery as claimed in claim 1, wherein the fixing tape surrounds a lower end portion of the electrode assembly.

13. An encased and capped secondary battery, comprising:
a jelly-roll shaped electrode assembly in which first and second electrode plates are coated with active material layers, each of which has a different polarity, and are wound together with a separator interposed therebetween; and
a fixing tape disposed around the jelly-roll shaped electrode assembly having a predetermined elasticity so as to maintain a wound state of the jelly-roll shaped electrode assembly, the fixing tape being sufficiently permeable such that electrolytes and/or ions present in the battery are able to pass through the fixing tape.

14. The secondary battery according to claim 13, wherein:
the separator prevents a short circuit from occurring between the first and second electrode plates and allows electric charge to move freely,
the separator comprises materials selected from the group consisting of at least polyethylene, polypropylene, and copolymer of polyethylene and polypropylene, and
the separator is wider than the first and second electrode plates.

15. The secondary battery according to claim 13, wherein the fixing tape is attached to side end portions of the jelly-roll shaped electrode assembly.

16. An encased and capped secondary battery, comprising:
a jelly-roll shaped electrode assembly in which first and second electrode plates are coated with active material layers, each of which has a different polarity, and are wound together with a separator interposed therebetween to have an original shape; and
a fixing tape disposed around the jelly-roll shaped electrode assembly having a predetermined elasticity sufficiently low enough to allow the electrode assembly to expand during a charging operation and sufficiently high enough to cause the electrode assembly to return to the original shape following the charging operation, the fixing tape being sufficiently permeable such that electrolytes and/or ions present in the battery are able to pass through the fixing tape.
